(19) United States
(12) Patent Application Publication
(10) Pub. No.: US 2026/0101325 A1
(43) Pub. Date: Apr. 9, 2026

(54) SEMI-PERSISTENT SIGNALING FOR FULL DUPLEX CAPABLE UES IN SUBBAND FULL DUPLEX NETWORKS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 18/909,159

(22) Filed: Oct. 8, 2024

(51) Int. Cl. H04W 72/11; H04L 5/14; H04W 72/0446

(52) U.S. Cl. CPC H04W 72/11; H04L 5/14; H04W 72/0446

(57) ABSTRACT

Certain aspects of the present disclosure provide techniques for semi-persistent signaling for full duplex (FD) capable user equipments (UEs) in subband full duplex (SBFD) networks. An example method, performed at a UE, generally includes receiving first signaling configuring the UE with semi-persistent resources for communications with a wireless node, receiving second signaling indicating additional information relating to a symbol type of the semi-persistent resources and a UE mode of operation for the communications, and communicating on the semi-persistent resources in accordance with the additional information.

### FIELD OF THE DISCLOSURE

Aspects of the present disclosure relate to wireless communications, and more particularly, to techniques for semi-persistent signaling for full duplex (FD) capable user equipments (UEs) in subband full duplex (SBFD) networks.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a user equipment (UE). The method includes receiving first signaling configuring the UE with semi-persistent resources for communications with a wireless node; receiving second signaling indicating additional information relating to a symbol type of the semi-persistent resources and a UE mode of operation for the communications; and communicating on the semi-persistent resources in accordance with the additional information.

Another aspect provides a method for wireless communication at a wireless node. The method includes transmitting first signaling configuring a user equipment (UE) with semi-persistent resources for communications with the wireless node; transmitting second signaling indicating additional information relating to a symbol type of the semi-persistent resources and a UE mode of operation for the communications; and communicating on the semi-persistent resources in accordance with the additional information.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIGS. 5A, 5B, and 5C depict various examples of full duplex (FD) time/frequency resource configurations.

FIGS. 6A, 6B, and 6C depict various examples of full duplex configurations.

FIGS. 7A and 7B depict an example of inter-UE cross link interference (CLI).

FIG. 8 depicts an example of an FD base station performing simultaneous transmission and reception.

FIGS. 9A and 9B depict example uplink and downlink subbands for subband FD (SBFD) operations.

FIG. 10 depicts example components to support FD communications.

FIGS. 11A and 11B depict example uplink and downlink subbands for subband FD (SBFD) operations.

FIG. 12 depicts an example call flow diagram, in accordance with aspects of the present disclosure.

FIG. 13 depicts an example of time resources for FD communications.

FIG. 14 depicts an example of adaptations of semi-persistent signaling occasions in time resources for FD communications.

FIG. 15 depicts a method for wireless communications.

FIG. 16 depicts a method for wireless communications.

FIG. 17 depicts aspects of an example communications device.

### DETAILED DESCRIPTION

Aspects of the present disclosure provide apparatuses, methods, processing systems, and computer-readable mediums for semi-persistent signaling for full duplex (FD) capable UEs in subband full duplex (SBFD) networks.

The term full duplex (FD) generally refers to simultaneous transmission and reception over a wireless medium. An FD device is, thus, capable of processing bi-directional transmissions at the same time. In contrast, a half-duplex (HD) device is only capable of transmitting or receiving, at one time, but not both.

If a user equipment (UE) is operating in HD mode (e.g., an HD UE) and a network entity, such as a gNodeB (gNB), is operating in an FD mode, such as sub-band FD (SBFD) or in-band FD (IBFD), interference may occur at the UE and gNB from a number of sources. For example, this interference may include inter-cell interference (ICI) from other gNBs, intra-cell cross-link interference (CLI) from UEs in the same cell, and inter-cell CLI from UEs in adjacent cells. Self-interference may also occur for both FD UEs and FD gNBs. In the case of FD gNBs, for example, self-interference may refer to a downlink transmission interfering with reception of an uplink transmission. These sources of interference may cause significant issues, including decreased spectral efficiency, increased power consumption, and poor UE performance.

In SBFD communication, guard bands may be used to separate frequency resources allocated for downlink (DL) and uplink (UL) signaling. In SBFD, the downlink and uplink signals may be transmitted on different subbands within the same frequency band. The guard band is a portion of the spectrum that is not used for either downlink or uplink communication, but is instead reserved to separate the subbands used for downlink and uplink signaling, preventing interference between them and allowing for a more reliable and efficient use of the available spectrum.

Some studies have focused on partially and fully overlapping UL and DL subbands operation at the network (e.g., base station/gNB) side. However, different challenges exist for UE-side FD operation. This is because to support FD operation, a UE may need to achieve improved spatial and frequency isolation to avoid self-interference while simultaneously transmitting and receiving. Spatial isolation may be achieved, for example, via separate Tx/Rx antennas (or panels) or via a single shared antenna with enhanced circulator/duplexer design. Frequency isolation may be achieved, for example, by using various analog and digital filtering and interference cancelation components.

Semi-persistent resources, such as resources used in Configured Grant (CG) based signaling for uplink and Semi-Persistent Scheduling (SPS) based signaling for uplink and downlink, use pre-allocated resources that reduce the need for continuous dynamic scheduling. With semi-persistent configurations, the network reserves specific resources for the UE to use periodically, typically for applications with predictable traffic patterns. This pre-configuration minimizes (control) signaling overhead and decreases latency by eliminating the need for the UE to request and wait for a new scheduling grant each time it has data to send or receive. There may be different approaches to configure semi persistent (SP) signaling (e.g., SPS/CG) for SBFD slots.

According to a first approach (Config1), RRC configuration specifies a symbol type (e.g., SBFD or non-SBFD) for which a configuration should be valid. In a Config1 scenario, there may be two different sets of configurations of SP resources, where a first configuration of SP resources is valid in HD slots and a second configuration of SP resources is valid in SBFD slots.

According to a second approach (Config2), there may be no restriction on the symbol type for which a configuration of SP resources will be valid. However, in a Config2 scenario, adaptation to the configuration may be applied based on the slot type.

These approaches assume an HD UE. However, with a full-duplex (FD) UE mode of operation, the effective downlink (DL) and uplink (UL) sub-bands are potentially different from that of the SBFD slot with an HD mode of operation (of the UE). In addition, (e.g., based on UE capability) a UE with a full-duplex mode of operation may have a smaller quantity of antennas for the DL reception and/or the UL transmission.

Aspects of the present disclosure provide techniques for handling semi-persistent signaling (e.g., SPS and CG) in SBFD networks with a full-duplex mode/capable UE. According to certain aspects, for example, a UE may be configured with additional information (e.g., indicating restrictions and/or adaptations) relating to a symbol type of semi-persistent (SP) resources and a UE mode of operation. The UE may communicate on the SP resources in accordance with the restrictions/adaptations. In some aspects, the full-duplex capable UE may still operate in HD slots, SBFD slots with HD mode, and SBFD slots with full-duplex mode. Utilization of the techniques disclosed herein may resolve the issues associated with communications in SBFD slots with different UE modes of operation (e.g., HD and FD), while extending Config1 and Config2 to achieve additional specificity based on UE mode of operation.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

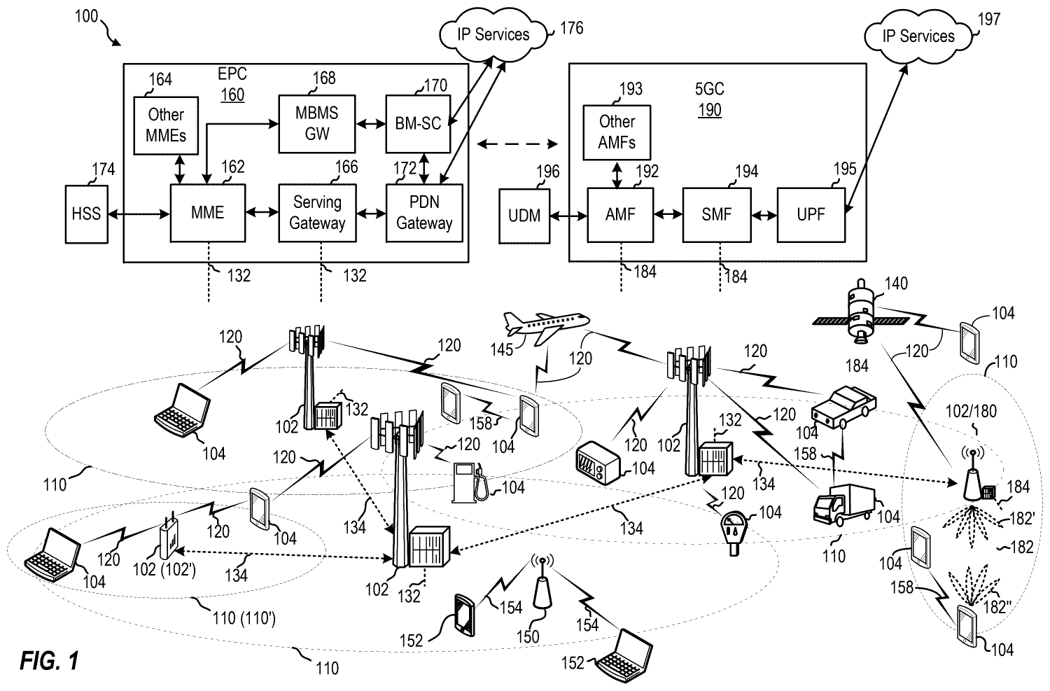

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

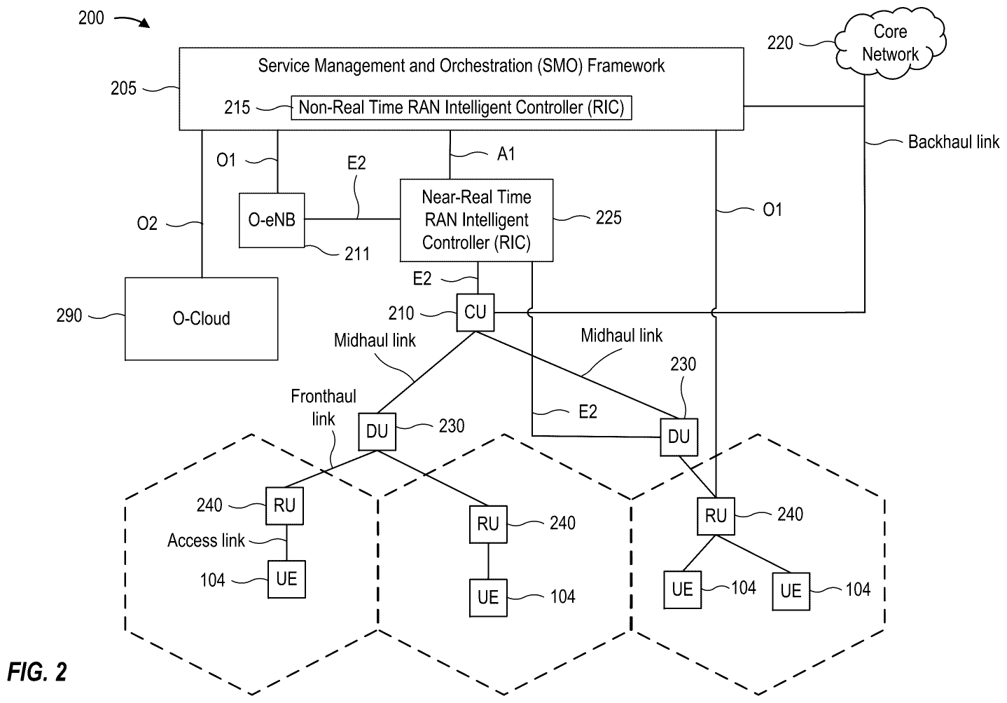

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz - 7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

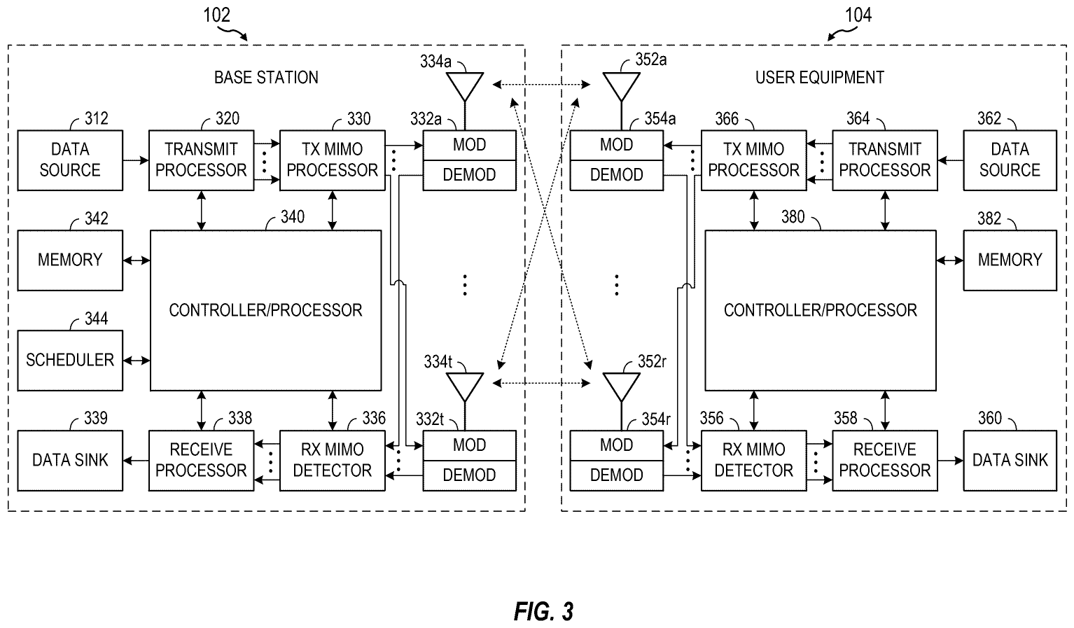

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

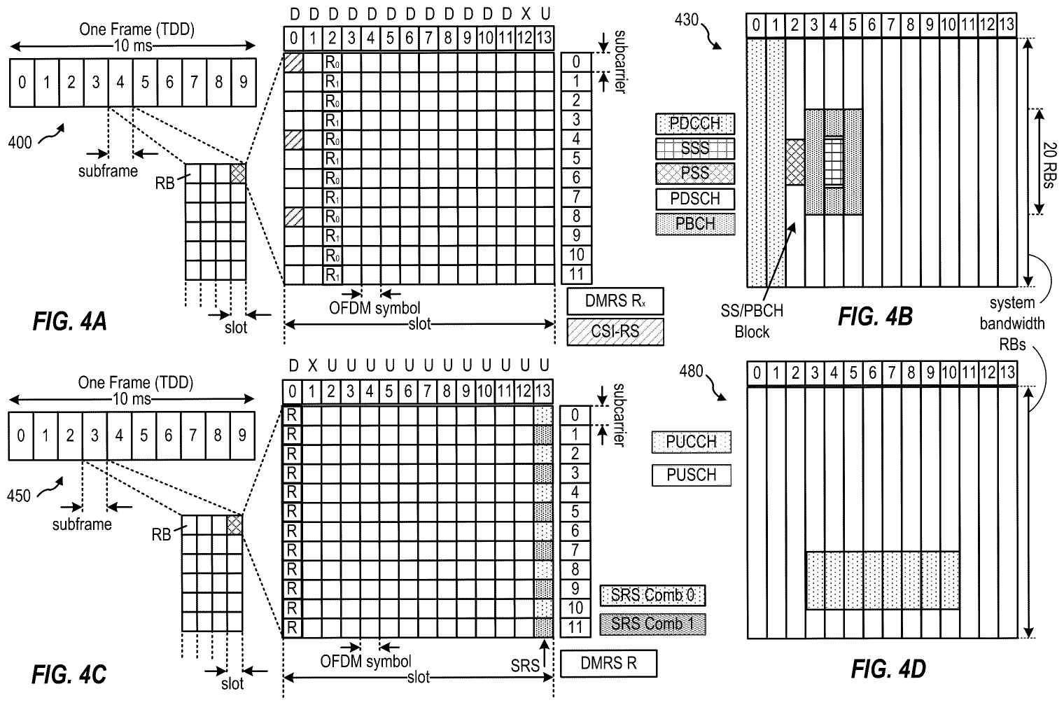

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μslots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Full Duplex Communication

As noted above, a full-duplex (FD) device is capable of simultaneous bi-directional communications. In contrast, half-duplex (HD) devices are only capable of communications in one direction (transmit or receive) at one time.

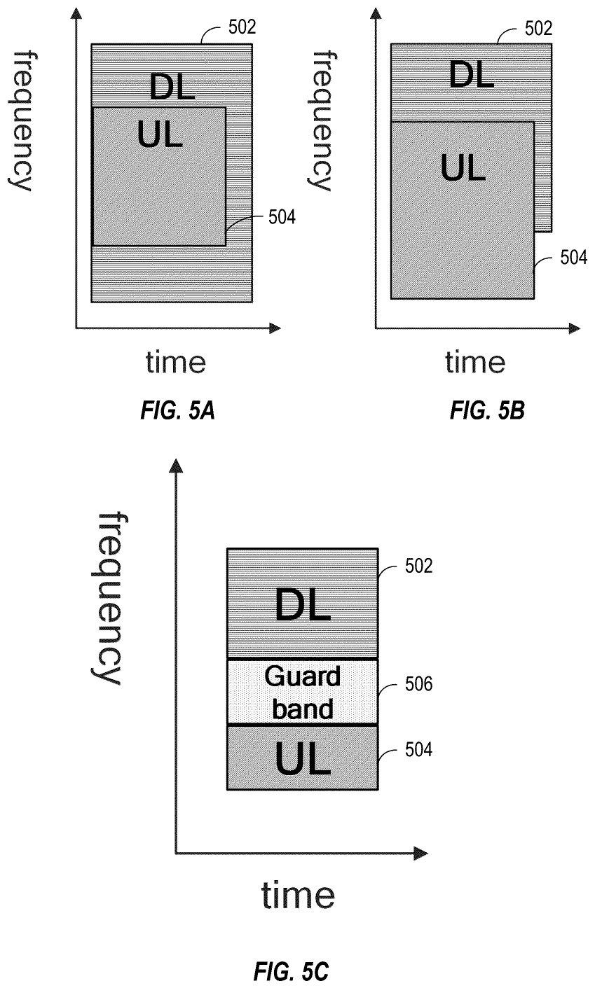

Examples of FD communication modes include in-band FD (IBFD) and sub-band FD. As illustrated in FIGS. 5A and 5B, with IBFD, a device may transmit and receive on the same time and frequency resources. In this case, the downlink (DL) 502 and uplink (UL) 504 shares the same IBFD time and frequency resources which may fully overlap (FIG. 5A) or partially overlap (FIG. 5B).

As shown in FIG. 5C, with SBFD (also referred to a flexible duplexing), a device may transmit and receive at the same time, but using different frequency resources. In this case, the DL resource may be separated from the UL resource, in frequency domain, by a guard band 506.

Interference to a UE and/or a network entity (e.g., a base station such as a gNB or node of a disaggregated base station) operating in FD mode may come in the form of CLI from neighboring nodes, as well as self-interference (SI). FIG. 5A, FIG. 5B, FIG. 5C, and FIG. 5D illustrate example interference scenarios for various FD communication use cases.

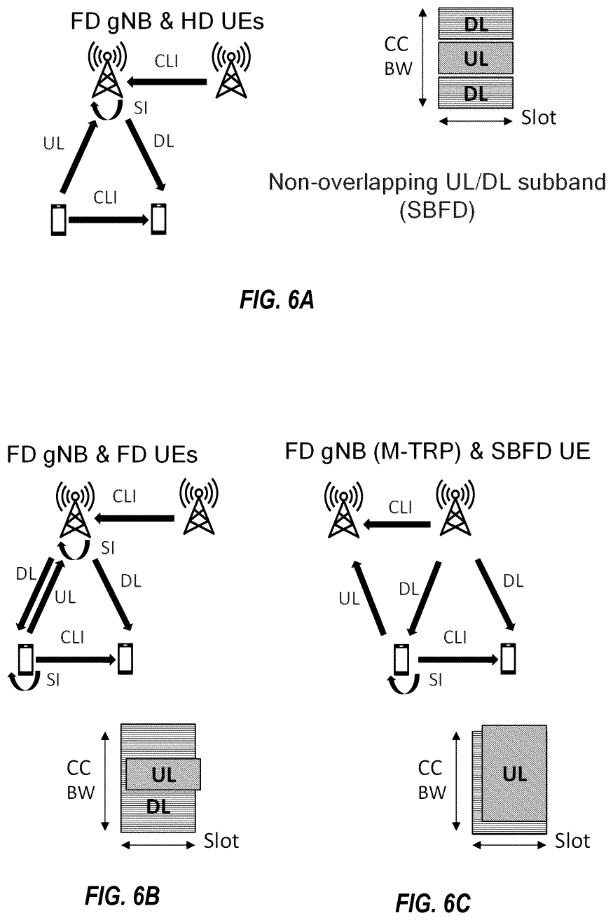

As illustrated in FIG. 6A, a first scenario is when FD is enabled for a gNB (e.g., with non-overlapping UL/DL subbands) but disabled for each connected UE (which in turn may be enabled for half-duplex (HD) communication), a gNB communicates using FD capabilities. In this case, CLI between UEs, SI from the FD gNB, and CLI between the gNB and neighboring gNBs interferes with FD communication.

As illustrated in FIG. 6B, a second scenario is when FD is enabled for both a gNB and a FD UE/customer premise equipment (CPE) connected to the gNB, the gNB communicates with the FD UE using FD capabilities. If the gNB is connected to an HD UE alongside the FD UE, the gNB communicates with the HD UE. In this case, CLI between UEs, SI from the gNB and the FD UE, and CLI between the FD gNB and neighboring gNBs interferes with FD communication.

As illustrated in FIG. 6C, a third scenario is when FD is enabled for two gNBs (e.g., in a multiple TRP scenario) and enabled at one UE/CPE connected to the two gNBs. In this case, the two gNBs may communicate with the FD UE using FD capabilities. If one of the two gNBs is connected to an HD UE alongside the FD UE, the one gNB communicates with both the HD UE and the FD UE. In this case, CLI between UEs, SI from the FD UE, and CLI between the two gNBs may interfere with FD communication.

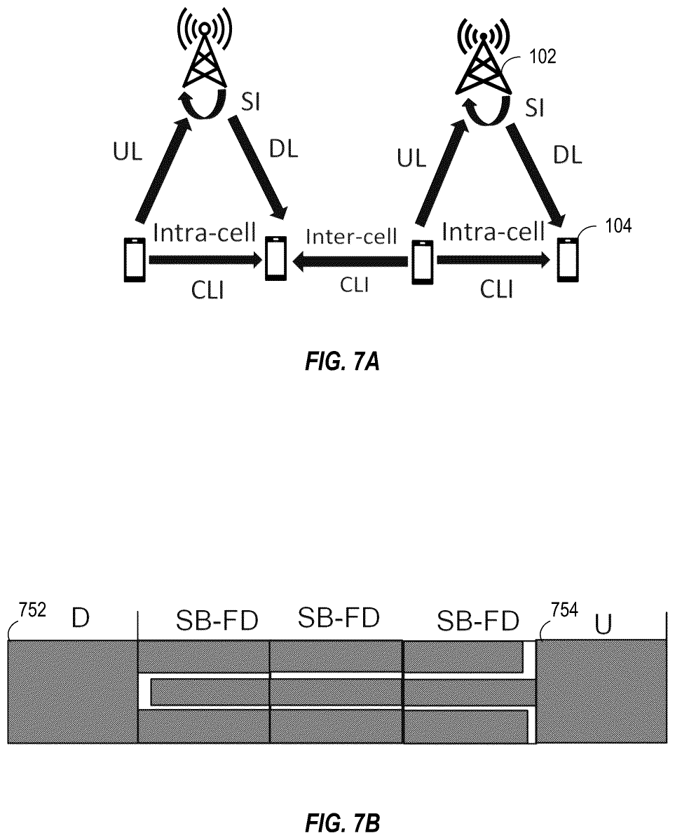

FIG. 7A also illustrates various forms of interference for FD communications. As illustrated, if a UE 104 is operating in HD mode and a gNB 102 is operating in FD (mode) SBFD/IBFD, sources of interference at the UE include inter-cell interference from other gNBs, intra-cell CLI from UEs in the same cell, and inter-cell CLI from UEs in adjacent cells. Additionally, there may be self-interference for full-duplex UEs, particularly in SBFD slots that include both uplink subbands 754 and downlink subbands 752, as shown in FIG. 7B.

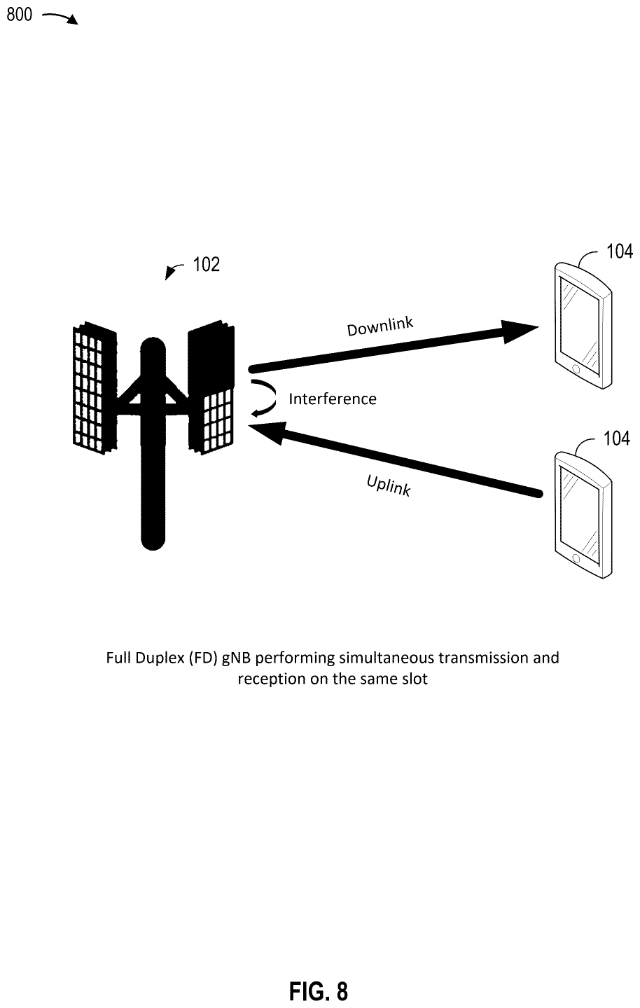

As noted above, an FD enabled device is capable of bi-directional network data transmissions at the same time. FIG. 8 illustrates an example of an FD enabled base station (an FD gNB) performing simultaneous transmission and reception on a same slot. As shown, the FD gNB may simultaneously perform a downlink transmission and receive an uplink transmission. As illustrated, the downlink transmission may be intended for a first UE, and the uplink transmission may be received from a second UE. In some cases, the downlink transmission and uplink transmission may both be associated with the same UE (e.g., if the UE is an FD UE). The simultaneous transmission and reception in a same slot may cause interference, as illustrated.

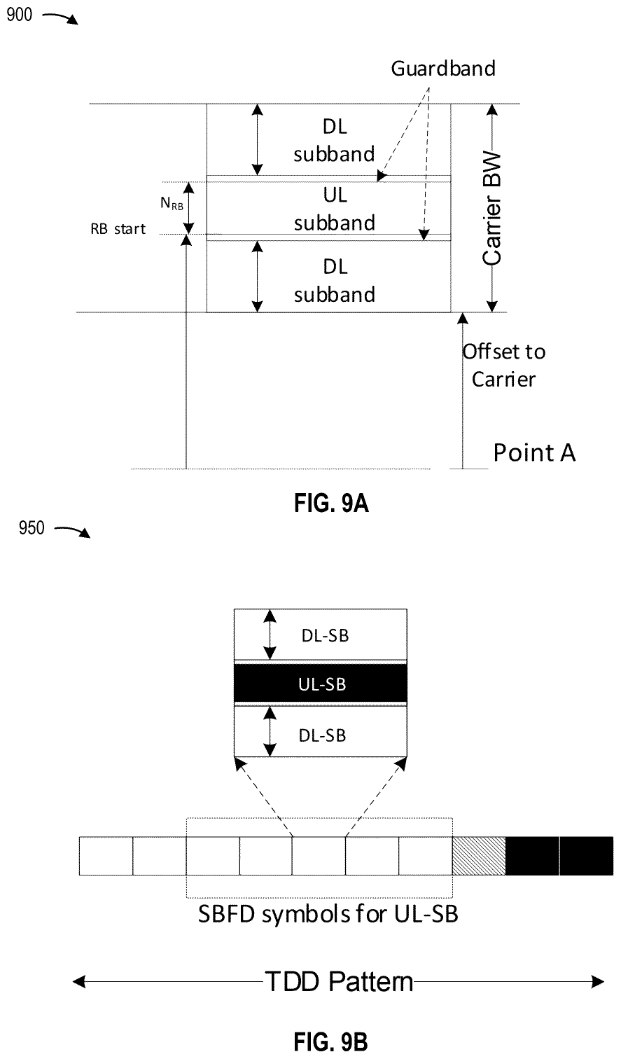

FIGS. 9A and 9B depict example uplink (UL) and downlink (DL) subbands for SBFD operations.

As illustrated in FIG. 9A, for example, UL and DL subbands may be allocated for SBFD operations within a carrier bandwidth (BW). As illustrated, for example, an UL subband allocation (e.g., and/or a DL subband allocation) may span N_{RB} resource blocks (RBs). As noted above, and as illustrated, UL subbands and DL subbands may be separated by guard bands.

As illustrated in FIG. 9B, a time division duplexing (TDD) pattern may indicate a semi-static configuration of subband time locations for SBFD operation. In such cases, frequency locations of DL subband(s) may be explicitly configured with guardband(s), if any, implicitly derived as RBs which are not within UL subband or DL subband(s). In other cases, a number of RBs for guardband(s), if any, is explicitly configured. In such cases, DL subband(s) may be implicitly derived as RBs which are not within UL subband or guardband(s).

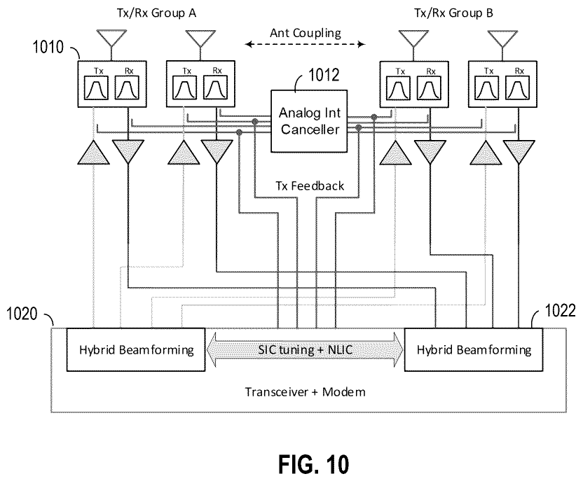

Certain features may be implemented at a UE to support FD operation in SBFD slots/symbols. For example, as illustrated in FIG. 10, various components may be used to achieve improved spatial and frequency isolation to avoid self-interference while simultaneously transmitting and receiving. Components may be designed to achieve blocking, to achieve a maximum input RF power and/or reduce sensitivity to incoming signals (Rx de-sense).

Spatial isolation may be achieved, for example, via separate Tx/Rx antennas groups (or panels) or via a single shared antenna with enhanced circulator/duplexer design. Frequency isolation may be achieved, for example, by using various analog and digital filtering 1010 and interference cancelation components 1012. As illustrated, a transceiver/modem 1020 may also have components for advanced techniques, such as hybrid beamforming (a combination of analog and digital beamforming) 1022, successive interference cancellation (SIC), and/or non-linear interference cancellation (NLIC).

In SBFD slots serving HD operation by a UE (referred to herein as an HD-UE or a UE with an HD mode of operation), a guard band may not need to be very large to protect the network from its self-interference, because the network may be able to have large spatial separation and, typically, more sophisticated ways to cancel self-interference (than at the UE).

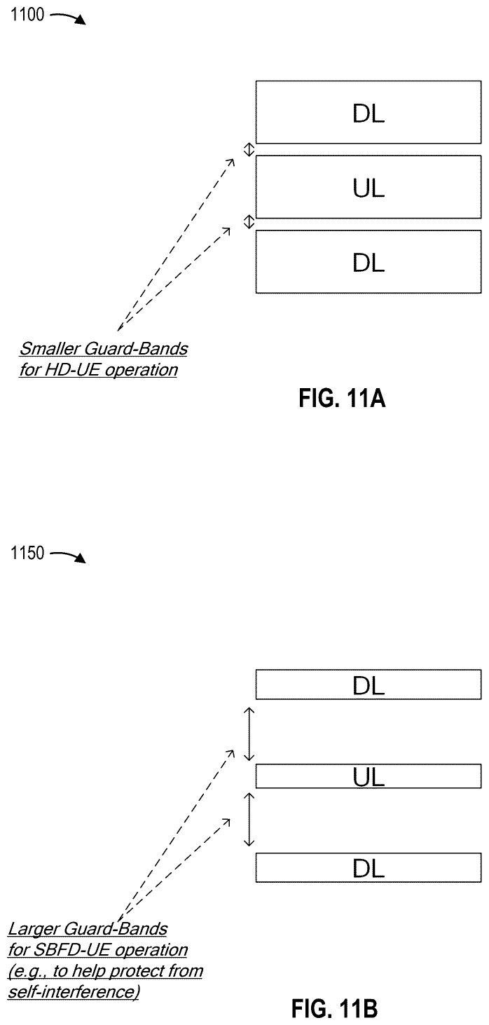

Thus, as illustrated by comparison of diagram 1100 of FIG. 11A to diagram 1150 of FIG. 11B, the guard bands in an SBFD slot serving an HD UE may be much smaller than the guard bands of an SBFD slot serving an SBFD-UE. The signaling mechanisms provided herein may enable a UE to select appropriate filters in advance, taking into consideration the difference in frequency configurations and different guard band sizes.

### Aspects Related to Semi-Persistent Signaling for FD-Capable UEs in SBFD Networks

As noted above, according to a first approach (Config1), RRC configuration specifies a symbol type (e.g., SBFD or non-SBFD) for which this configuration should be valid. In a Config1 scenario, there may be two different sets of configurations of SP resources, where a first configuration of SP resources is valid in HD slots and a second configuration of SP resources is valid in SBFD slots. According to a second approach (Config2), there may be no restriction on the symbol type for which a configuration of SP resources will be valid. However, in a Config2 scenario, adaptation to the configuration may be applied based on the slot type.

These approaches assume an HD UE. However, with a full-duplex (FD) UE mode of operation, the effective downlink (DL) and uplink (UL) sub-bands are potentially different from that of the SBFD slot with an HD mode of operation (of the UE). In addition, (e.g., based on UE capability) a UE with a full-duplex mode of operation may have a smaller quantity of antennas for the DL reception and/or the UL transmission.

Aspects of the present disclosure provide techniques for handling semi-persistent signaling (e.g., SPS and/or CG) in SBFD networks with a full-duplex mode/capable UE. According to certain aspects, for example, a UE may be configured with additional information (e.g., indicating restrictions and/or adaptations) relating to a symbol type of semi-persistent (SP) resources and a UE mode of operation. The UE may communicate on the SP resources in accordance with the restrictions/adaptations. In some aspects, the full-duplex capable UE may still operate in HD slots, SBFD slots with HD mode, and SBFD slots with FD mode.

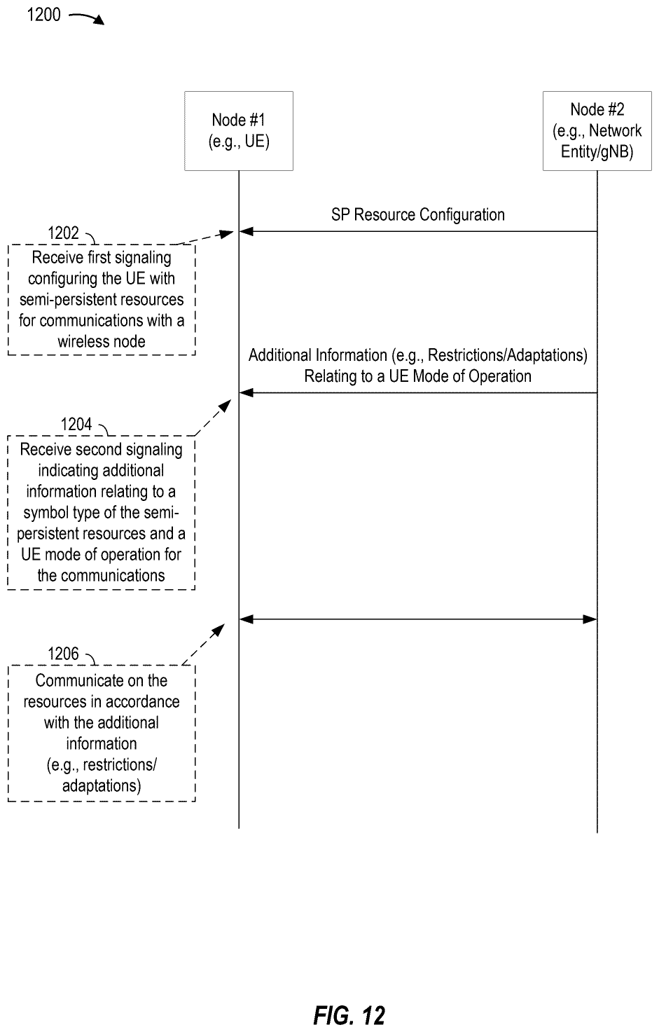

These techniques may be understood with reference to call flow diagram 1200 of FIG. 12. In some aspects, the first wireless node (Node #1) shown in FIG. 12 may be an example of the UE 104 depicted and described with respect to FIGS. 1 and 3. In some aspects, the second wireless node (Node #2) shown in FIG. 12 may be an example of the BS 102 (e.g., a gNB) depicted and described with respect to FIGS. 1 and 3 or a disaggregated base station depicted and described with respect to FIG. 2.

In some aspects, as illustrated at 1202, the first wireless node (e.g., UE) may receive first signaling (e.g., semi-persistent resource configuration(s) for SPS based signaling and/or CG based signaling) configuring the UE with semi-persistent resources for communications with a wireless node (e.g., a gNB). In some aspects, the first signaling may be RRC configuration signaling.

As illustrated at 1204, the first wireless node may receive second signaling indicating additional information (e.g., restrictions and/or adaptations) relating to a symbol type of the semi-persistent resources and a UE mode of operation for the communications. The second signaling may be RRC configuration signaling or downlink control information (DCI). In some aspects, the first and second signaling may be transmitted together as a single transmission, or the first and second signaling may (each) refer to a plurality of transmissions.

As illustrated at 1206, the first and second wireless nodes may communicate (e.g., participate in FD communication) in accordance with the additional information (e.g., restrictions/adaptations).

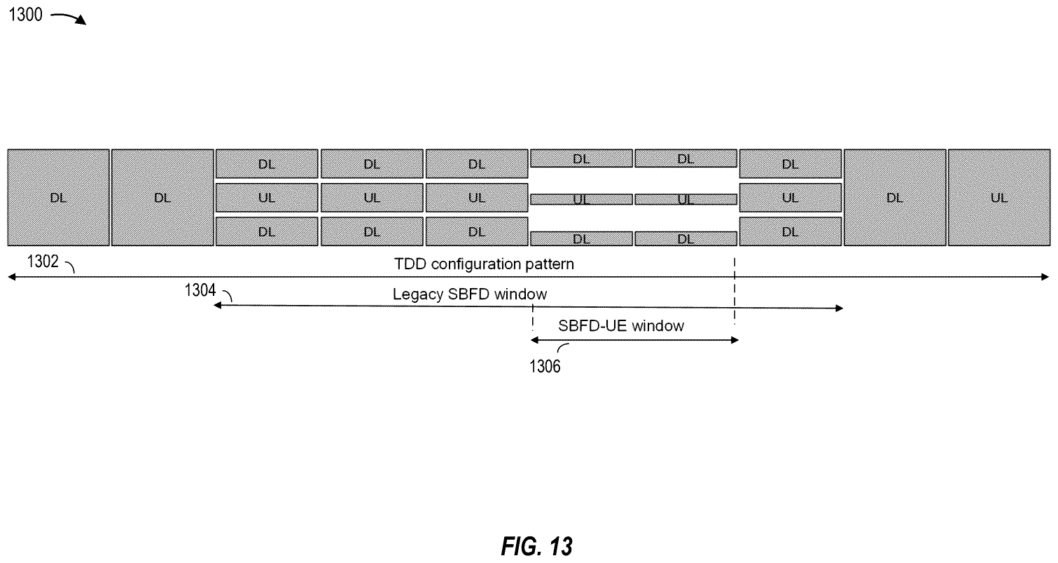

As illustrated in diagram 1300 of FIG. 13, SBFD-UE time resources may be (indicated as) a second window 1306 within a first window 1304 of legacy SBFD time resources. In this case, the legacy SBFD window 1304 may be indicated as SBFD slots within a TDD configuration pattern 1302. In some cases, the first window 1304 may be indicated via a semi-static indication of SBFD subband time location.

In some cases, legacy SBFD symbols may be configured in consecutive manner (e.g., within TDD-UL-DL pattern 1302). In some cases, legacy SBFD symbols may be configured in DL and/or flexible symbols (e.g., configured via TDD-UL-DL-ConfigCommon parameter). The SBFD-UE window may be indicated according to various options. As illustrated in FIG. 13, the SBFD-UE window could be located fully within the legacy SBFD window.

As noted above, in an SBFD slot for an HD-UE (e.g., a UE operating in an HD mode), a guard band does not need to be large to protect the network from its self-interference because the network can have large spatial separation and more sophisticated ways to cancel self-interference at the gNB side. For example, since the UE may operate in an FD mode in the SBFD-UE window 1306, the guard bands in the SBFD-UE window 1306 are larger than the guard bands in the non-SBFD-UE portions of the legacy SBFD window. In some cases, a legacy SBFD window and SBFD-UE window may at least partially overlap. In other cases, a legacy SBFD window and SBFD-UE window may not overlap.

According to certain aspects of the present disclosure (e.g., in a Config1 scenario/as an extension to Config1), the network may indicate (e.g., via RRC) one or more restrictions to a symbol type (e.g., SBFD or non-SBFD) and UE mode of operation (e.g., HD, FD, or both).

In some aspects, downlink control information (DCI) activating SPS/CG signaling with Config1 may include one or more bits to indicate the slot type as well as the UE mode for which the configuration should adapt. In some aspects, the interpretation of bits may be identified/based on an RRC configured mapping as follows:
00: HD only (e.g., HD symbol type only and/or HD mode of operation only);
01: SBFD-slot with HD mode only;
10: SBFD-slot with FD mode only; and
11: All SBFD slots (e.g., with FD mode or HD mode-regardless of UE mode of operation).
   The interpretation of bit values described above is an illustrative example of a possible interpretation of bits in DCI, but different combinations/interpretations are possible in accordance with aspects of the present disclosure.

According to certain aspects of the present disclosure (e.g., in a Config2 scenario), Config2 adaptations may be extended to include adaptations for each UE mode of operation (e.g., HD and FD) in SBFD slots. For example, Config2.a may define adaptations applied to the configuration when the SP occasion falls in SBFD slot and the UE is in an HD mode of operation. Config2.b may define adaptations applied to the configuration when the SP occasion falls in an SBFD slot and the UE is in an FD mode of operation.

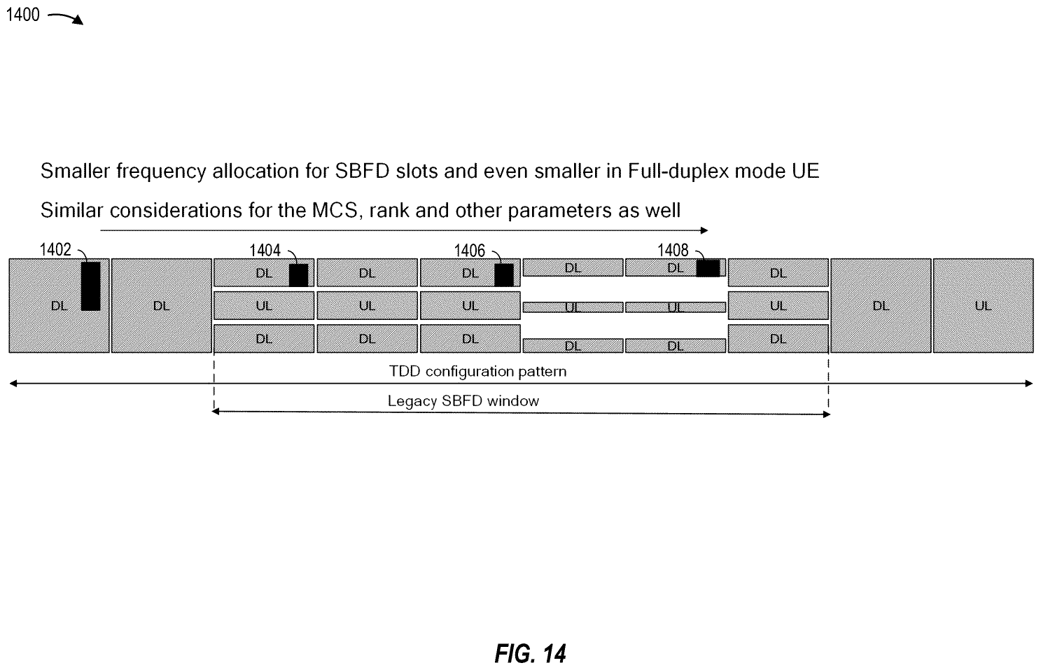

These techniques may be understood with reference to FIG. 14, which depicts an example diagram 1400 illustrating adaptations of semi-persistent signaling occasions in time resources for FD communications.

As illustrated at 1402, an SP resource occasion (e.g., an SPS or CG occasion) may occur in an HD slot for downlink communication (e.g., reception by a UE).

As illustrated at 1404 and 1406, SP resource occasions may occur in SBFD slots where the UE is operating with an HD mode of operation. In such cases, as illustrated, certain adaptations may be applied to the SP resource occasions 1404 and 1406, in accordance with additional information received (e.g., from the network). For example, the frequency allocation of the SP resource occasions may be adapted to be smaller (than the frequency allocation of the SP resource occasion 1402 in the HD slot). Adaptations may be applied for certain other parameters (e.g., MCS, Rank, and/or RB offset). In some aspects, rate matching may be performed as an adaptation in a slot.

As illustrated at 1408, an SP resource occasion may occur in an SBFD slot where the UE is operating in an FD mode of operation. As illustrated, a different adaptation may be applied to the SP resource occasion in this case, based on additional information received from the network. For example, as illustrated, the frequency allocation for SP resource occasions in SBFD slots with an FD-mode UE may be even smaller than the frequency allocation for SP resource occasions in SBFD slots with an HD-mode UE. Similarly, other adaptations may also be configured to be different for different scenarios (e.g., different slot types and/or UE modes of operation).

In some aspects, SPS based signaling and CG based signaling may collide in an SBFD slot with FD mode. In such cases, certain collision rules may be applied. For example, when SPS Config1 signaling and CG Config1 signaling collide, where the SPS and CG based signaling are both only meant for (e.g., restricted to) an SBFD slot and FD mode, the collision may be allowed.

In some aspects, when SPS Config1 signaling and CG Config2.b signaling collide, where the SPS based signaling is meant for (e.g., restricted to) an SBFD slot and FD mode and the CG based signaling is adapted for FD mode, the collision rules may permit/require that the CG based signaling: be dropped, transmitted with Config2.b adaptations, or transmitted with Config2.b adaptations and additional adaptation(s) specific for the case/scenario. In some cases, such techniques may be applied in the reverse/opposite way (e.g., for when SPS Config2.b and CG Config1 signaling collide).

In some aspects, when SPS Config2.b and CG Config2.b signaling collide (e.g., when both configurations are adapted with Config2.b adaptations), the collision rules may permit/require that both the SPS and CG based signaling are allowed, or that the SPS based signaling is dropped, or that the CG based signaling is dropped.

As noted above, determining an FD capable slot may be based on semi-static or dynamic techniques (e.g., based on the scheduling techniques used). In some cases (e.g., 3GPP Release-19, supporting only HD UEs), collision between SPS based signaling and CG based signaling may be prohibited or considered as an error case unless a direction is indicated. If a direction is indicated, one of the SPS based signaling and CG based signaling may dropped.

For an FD capable UE, if both SPS based signaling and CG based signaling collide in the same SBFD slot and no direction is indicated, it may be beneficial to utilize the collision to convert the slot to an SBFD slot with FD capable operation.

Aspects of the present disclosure provide techniques for dynamic indication of FD mode switching based on collision between SPS and CG. According to aspects of the present disclosure, each SPS and CG configuration may include a new parameter (e.g., allow_conversion_to_FD) which may indicate whether conversion of an SBFD slot to FD mode (e.g., conversion of the UE mode of operation in the SBFD slot to FD mode) is permitted. In some aspects, if SPS and CG occasions overlap in an SBFD slot, and one or both of their configurations have the parameter(s) allow_conversion_to_FD enabled (e.g., indicated by a bit value), the UE may implicitly assume conversion to FD mode is possible and permitted. In such cases, the SBFD slot/UE mode of operation may be converted to FD mode accordingly. This conversion may be limited to the (single) SBFD slot, valid for a (e.g., RRC configured) quantity of (e.g., consecutive) slots, or valid until the end of a window of (e.g., consecutive) SBFD slots.

Utilization of the techniques disclosed herein may resolve the issues associated with communications in SBFD slots with different UE modes of operation (e.g., HD and FD), while extending Config1 and Config2 to achieve additional specificity based on UE mode of operation.

### Example Operations

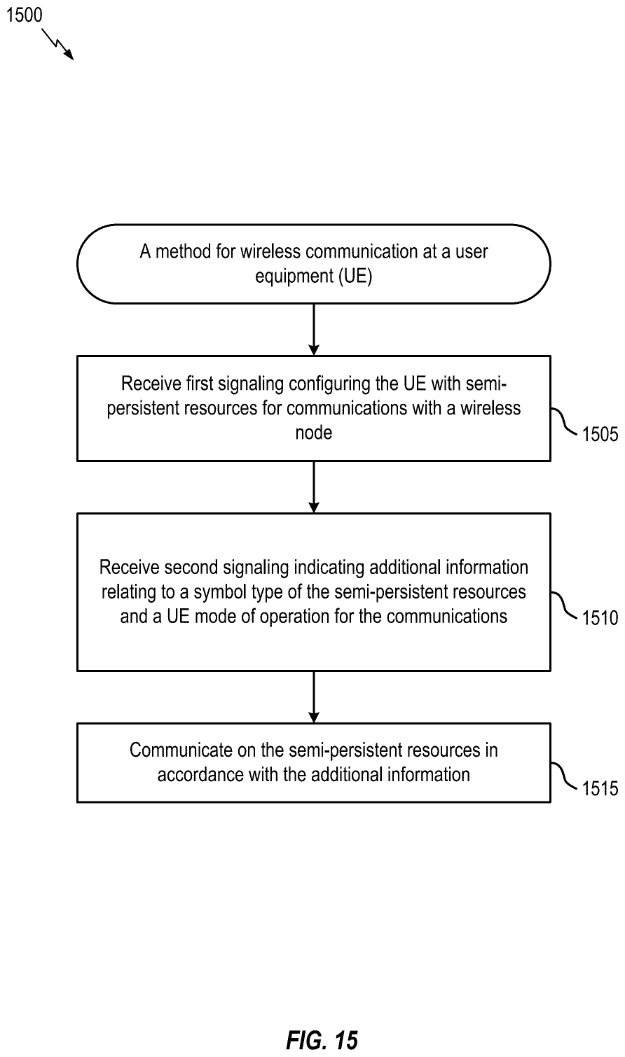

FIG. 15 shows an example of a method 1500 of wireless communication at a user equipment (UE), such as a UE 104 of FIGS. 1 and 3.

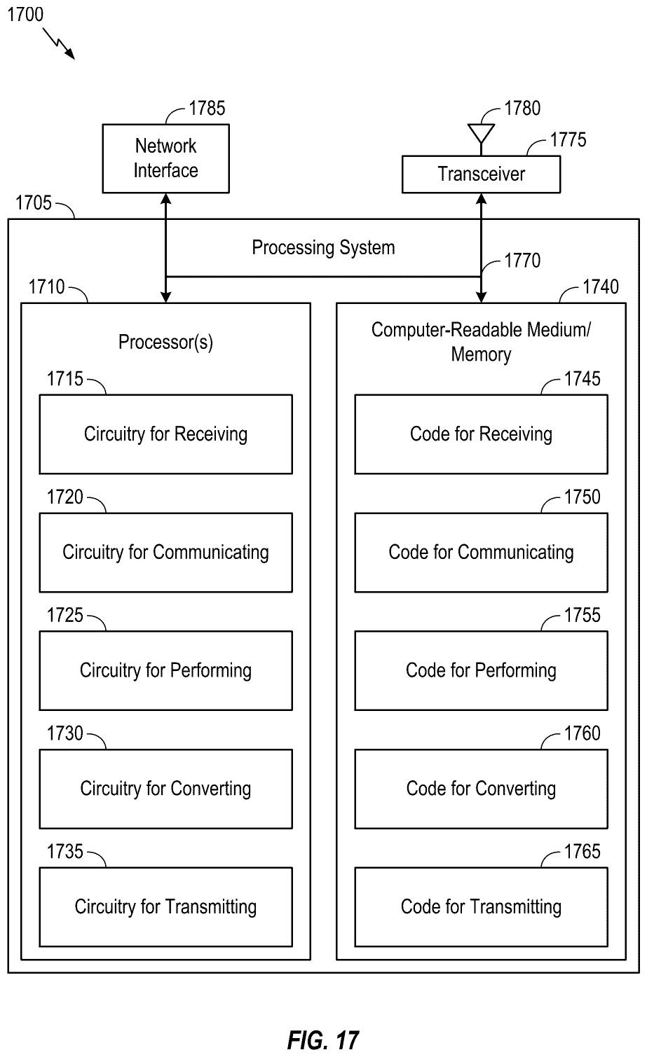

Method 1500 begins at step 1505 with receiving first signaling configuring the UE with semi-persistent resources for communications with a wireless node. In some cases, the operations of this step refer to, or may be performed by, circuitry for receiving and/or code for receiving as described with reference to FIG. 17.

Method 1500 then proceeds to step 1510 with receiving second signaling indicating additional information relating to a symbol type of the semi-persistent resources and a UE mode of operation for the communications. In some cases, the operations of this step refer to, or may be performed by, circuitry for receiving and/or code for receiving as described with reference to FIG. 17.

Method 1500 then proceeds to step 1515 with communicating on the semi-persistent resources in accordance with the additional information. In some cases, the operations of this step refer to, or may be performed by, circuitry for communicating and/or code for communicating as described with reference to FIG. 17.

In some aspects, the communications comprise at least one of semi-persistently scheduled (SPS) or configured grant (CG) based transmissions or receptions.

In some aspects, the additional information indicates restriction to a symbol type and a UE mode of operation for the communications, and the communicating comprises communicating on the semi-persistent resources in accordance with the restriction.

In some aspects, the restriction includes at least one of: a restriction to use the semi-persistent resources in half duplex (HD) slots only, a restriction to use the semi-persistent resources in subband full duplex (SBFD) slots indicated for HD mode of operation for the UE, a restriction to use the semi-persistent resources in SBFD slots indicated for full duplex (FD) mode of operation for the UE, or a restriction to use the semi-persistent resources in any SBFD slots regardless of indicated UE mode of operation.

In some aspects, the additional information indicates adaptations to be applied to the communications for one or more combinations of symbol type and UE mode of operation; and the communicating comprises applying the adaptations in at least one slot of the semi-persistent resources.

In some aspects, at least one of the adaptations involves rate matching in the at least one slot.

In some aspects, at least one of the adaptations involves adapting one or more parameters associated with communications in the at least one slot.

In some aspects, the one or more parameters comprise at least one of: a resource block (RB) offset in the at least one slot, a rank associated with the communications in the at least one slot, or a modulation and coding scheme (MCS) associated with the communications in the at least one slot.

In some aspects, the adaptations include at least one of: adaptations specific for a subband full duplex (SBFD) slot and a full duplex (FD) UE mode, adaptations specific for an SBFD slot and a half duplex (HD) UE mode, or adaptations specific for an SBFD slot and an FD UE mode, where only a downlink transmission or only an uplink transmission is scheduled in the SBFD slot.

In some aspects, the resources include first resources for SPS based communications and second resources for CG based communications; and the first resources and the second resources overlap in at least a first slot.

In some aspects, the method 1500 further includes performing one or more actions based on the overlap. In some cases, the operations of this step refer to, or may be performed by, circuitry for performing and/or code for performing as described with reference to FIG. 17.

In some aspects, the one or more actions comprise at least one of: dropping the CG based communications in at least the first slot; dropping the SPS based communications in at least the first slot; performing the CG based communications in accordance with an adaptation specific for the overlap; performing the SPS based communications in accordance with an adaptation specific for the overlap; or performing the SPS based communications and the CG based communications in accordance with the indicated adaptations.

In some aspects, the first signaling indicates permissibility of converting a mode of operation of the UE from half duplex (HD) mode to full duplex (FD) mode.

In some aspects, the method 1500 further includes converting the UE mode of operation from HD mode to FD mode based on the overlap and the first signaling. In some cases, the operations of this step refer to, or may be performed by, circuitry for converting and/or code for converting as described with reference to FIG. 17.

In some aspects, the conversion is at least one of: limited to the at least the first slot, valid for a configured quantity of slots, or valid until an end of a window of consecutive SBFD slots.

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

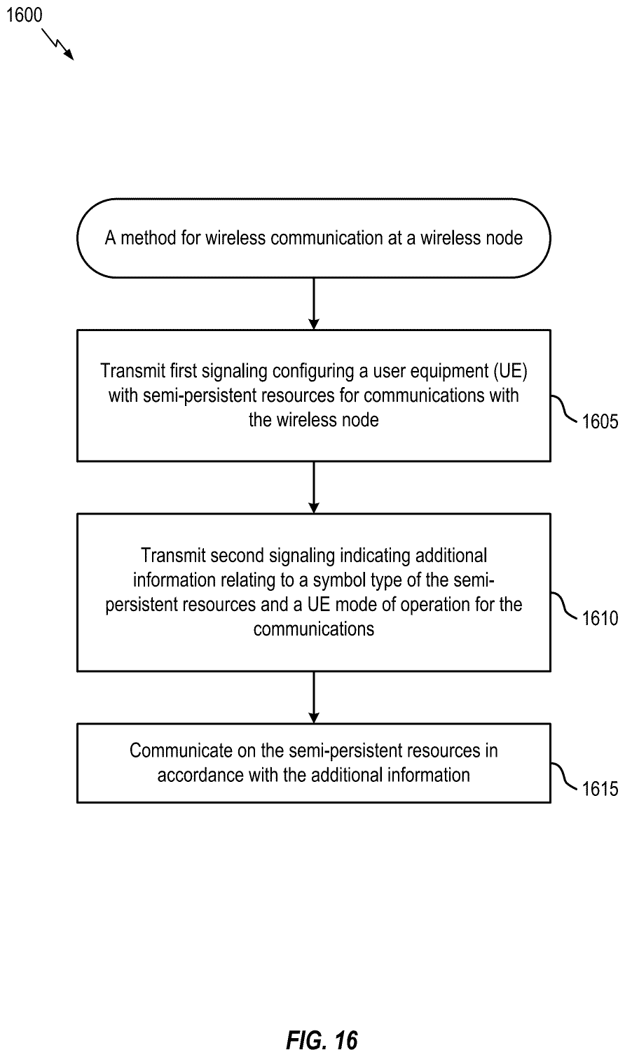

FIG. 16 shows an example of a method 1600 of wireless communication at a wireless node. In some examples, the wireless node is a user equipment, such as a UE 104 of FIGS. 1 and 3. In some examples, the wireless node is a network entity, such as a BS 102 of FIGS. 1 and 3, or a disaggregated base station as discussed with respect to FIG. 2.

Method 1600 begins at step 1605 with transmitting first signaling configuring a user equipment (UE) with semi-persistent resources for communications with the wireless node. In some cases, the operations of this step refer to, or may be performed by, circuitry for transmitting and/or code for transmitting as described with reference to FIG. 17.

Method 1600 then proceeds to step 1610 with transmitting second signaling indicating additional information relating to a symbol type of the semi-persistent resources and a UE mode of operation for the communications. In some cases, the operations of this step refer to, or may be performed by, circuitry for transmitting and/or code for transmitting as described with reference to FIG. 17.

Method 1600 then proceeds to step 1615 with communicating on the semi-persistent resources in accordance with the additional information. In some cases, the operations of this step refer to, or may be performed by, circuitry for communicating and/or code for communicating as described with reference to FIG. 17.

In some aspects, the communications comprise at least one of semi-persistently scheduled (SPS) or configured grant (CG) based transmissions or receptions.

In some aspects, the additional information indicates restriction to a symbol type and a UE mode of operation for the communications, and the communicating comprises communicating on the semi-persistent resources in accordance with the restriction.

In some aspects, the restriction includes at least one of: a restriction to use the semi-persistent resources in half duplex (HD) slots only, a restriction to use the semi-persistent resources in subband full duplex (SBFD) slots indicated for HD mode of operation for the UE, a restriction to use the semi-persistent resources in SBFD slots indicated for full duplex (FD) mode of operation for the UE, or a restriction to use the semi-persistent resources in any SBFD slots regardless of indicated UE mode of operation.

In some aspects, the additional information indicates adaptations to be applied to the communications for one or more combinations of symbol type and UE mode of operation; and the communicating comprises applying the adaptations in at least one slot of the semi-persistent resources.

In some aspects, at least one of the adaptations involves rate matching in the at least one slot.

In some aspects, at least one of the adaptations involves adapting one or more parameters associated with communications in the at least one slot.

In some aspects, the one or more parameters comprise at least one of: a resource block (RB) offset in the at least one slot, a rank associated with the communications in the at least one slot, or a modulation and coding scheme (MCS) associated with the communications in the at least one slot.

In some aspects, the adaptations include at least one of: adaptations specific for a subband full duplex (SBFD) slot and a full duplex (FD) UE mode, adaptations specific for an SBFD slot and a half duplex (HD) UE mode, or adaptations specific for an SBFD slot and an FD UE mode, where only a downlink transmission or only an uplink transmission is scheduled in the SBFD slot.

In some aspects, the resources include first resources for SPS based communications and second resources for CG based communications; and the first resources and the second resources overlap in at least a first slot.

In some aspects, the method 1600 further includes performing one or more actions based on the overlap. In some cases, the operations of this step refer to, or may be performed by, circuitry for performing and/or code for performing as described with reference to FIG. 17.

In some aspects, the one or more actions comprise at least one of: dropping the CG based communications in at least the first slot; dropping the SPS based communications in at least the first slot; performing the CG based communications in accordance with an adaptation specific for the overlap; performing the SPS based communications in accordance with an adaptation specific for the overlap; or performing the SPS based communications and the CG based communications in accordance with the indicated adaptations.

In some aspects, the first signaling indicates permissibility of converting a mode of operation of the UE from half duplex (HD) mode to full duplex (FD) mode.

In some aspects, the UE mode of operation is converted from HD mode to FD mode based on the overlap and the first signaling.

In some aspects, the conversion is at least one of: limited to the at least the first slot, valid for a configured quantity of slots, or valid until an end of a window of consecutive SBFD slots.

In one aspect, method 1600, or any aspect related to it, may be performed by an apparatus, such as communications device 1700 of FIG. 17, which includes various components operable, configured, or adapted to perform the method 1600. Communications device 1700 is described below in further detail.

Note that FIG. 16 is just one example of a method, and other methods including fewer, additional, or alternative steps are possible consistent with this disclosure.

### Example Communications Device(s)

FIG. 17 depicts aspects of an example communications device 1700. In some aspects, communications device 1700 is a user equipment, such as UE 104 described above with respect to FIGS. 1 and 3. In some aspects, communications device 1700 is a network entity, such as BS 102 of FIGS. 1 and 3, or a disaggregated base station as discussed with respect to FIG. 2.

The communications device 1700 includes a processing system 1705 coupled to the transceiver 1775 (e.g., a transmitter and/or a receiver). In some aspects (e.g., when communications device 1700 is a network entity), processing system 1705 may be coupled to a network interface 1785 that is configured to obtain and send signals for the communications device 1700 via communication link(s), such as a backhaul link, midhaul link, and/or fronthaul link as described herein, such as with respect to FIG. 2. The transceiver 1775 is configured to transmit and receive signals for the communications device 1700 via the antenna 1780, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1740 via a bus 1770. In certain aspects, the computer-readable medium/memory 1740 is configured to store instructions (e.g., computer-executable code) that when executed by the one or more processors 1710, cause the one or more processors 1710 to perform the method 1500 described with respect to FIG. 15, or any aspect related to it; and the method 1600 described with respect to FIG. 16, or any aspect related to it. Note that reference to a processor performing a function of communications device 1700 may include one or more processors 1710 performing that function of communications device 1700.

In the depicted example, computer-readable medium/memory 1740 stores code (e.g., executable instructions), such as code for receiving 1745, code for communicating 1750, code for performing 1755, code for converting 1760, and code for transmitting 1765. Processing of the code for receiving 1745, code for communicating 1750, code for performing 1755, code for converting 1760, and code for transmitting 1765 may cause the communications device 1700 to perform the method 1500 described with respect to FIG. 15, or any aspect related to it; and the method 1600 described with respect to FIG. 16, or any aspect related to it.

The one or more processors 1710 include circuitry configured to implement (e.g., execute) the code stored in the computer-readable medium/memory 1740, including circuitry for receiving 1715, circuitry for communicating 1720, circuitry for performing 1725, circuitry for converting 1730, and circuitry for transmitting 1735. Processing with circuitry for receiving 1715, circuitry for communicating 1720, circuitry for performing 1725, circuitry for converting 1730, and circuitry for transmitting 1735 may cause the communications device 1700 to perform the method 1500 described with respect to FIG. 15, or any aspect related to it; and the method 1600 described with respect to FIG. 16, or any aspect related to it.

Various components of the communications device 1700 may provide means for performing the method 1500 described with respect to FIG. 15, or any aspect related to it; and the method 1600 described with respect to FIG. 16, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1775 and the antenna 1780 of the communications device 1700 in FIG. 17. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1775 and the antenna 1780 of the communications device 1700 in FIG. 17.

### Example Clauses

Implementation examples are described in the following numbered clauses:

Clause 1: A method for wireless communication at a user equipment (UE), comprising: receiving first signaling configuring the UE with semi-persistent resources for communications with a wireless node; receiving second signaling indicating additional information relating to a symbol type of the semi-persistent resources and a UE mode of operation for the communications; and communicating on the semi-persistent resources in accordance with the additional information.

Clause 2: The method of Clause 1, wherein the communications comprise at least one of semi-persistently scheduled (SPS) or configured grant (CG) based transmissions or receptions.

Clause 3: The method of any one of Clauses 1-2, wherein: the additional information indicates restriction to a symbol type and a UE mode of operation for the communications, and the communicating comprises communicating on the semi-persistent resources in accordance with the restriction.

Clause 4: The method of Clause 3, wherein the restriction includes at least one of: a restriction to use the semi-persistent resources in half duplex (HD) slots only, a restriction to use the semi-persistent resources in subband full duplex (SBFD) slots indicated for HD mode of operation for the UE, a restriction to use the semi-persistent resources in SBFD slots indicated for full duplex (FD) mode of operation for the UE, or a restriction to use the semi-persistent resources in any SBFD slots regardless of indicated UE mode of operation.

Clause 5: The method of any one of Clauses 1-4, wherein: the additional information indicates adaptations to be applied to the communications for one or more combinations of symbol type and UE mode of operation; and the communicating comprises applying the adaptations in at least one slot of the semi-persistent resources.

Clause 6: The method of Clause 5, wherein at least one of the adaptations involves rate matching in the at least one slot.

Clause 7: The method of Clause 5, wherein at least one of the adaptations involves adapting one or more parameters associated with communications in the at least one slot.

Clause 8: The method of Clause 7, wherein the one or more parameters comprise at least one of: a resource block (RB) offset in the at least one slot, a rank associated with the communications in the at least one slot, or a modulation and coding scheme (MCS) associated with the communications in the at least one slot.

Clause 9: The method of Clause 5, wherein the adaptations include at least one of: adaptations specific for a subband full duplex (SBFD) slot and a full duplex (FD) UE mode, adaptations specific for an SBFD slot and a half duplex (HD) UE mode, or adaptations specific for an SBFD slot and an FD UE mode, where only a downlink transmission or only an uplink transmission is scheduled in the SBFD slot.

Clause 10: The method of Clause 5, wherein: the resources include first resources for SPS based communications and second resources for CG based communications; and the first resources and the second resources overlap in at least a first slot.

Clause 11: The method of Clause 10, further comprising performing one or more actions based on the overlap.

Clause 12: The method of Clause 11, wherein the one or more actions comprise at least one of: dropping the CG based communications in at least the first slot; dropping the SPS based communications in at least the first slot; performing the CG based communications in accordance with an adaptation specific for the overlap; performing the SPS based communications in accordance with an adaptation specific for the overlap; or performing the SPS based communications and the CG based communications in accordance with the indicated adaptations.

Clause 13: The method of Clause 10, wherein the first signaling indicates permissibility of converting a mode of operation of the UE from half duplex (HD) mode to full duplex (FD) mode.

Clause 14: The method of Clause 13, further comprising converting the UE mode of operation from HD mode to FD mode based on the overlap and the first signaling.

Clause 15: The method of Clause 14, wherein the conversion is at least one of: limited to the at least the first slot, valid for a configured quantity of slots, or valid until an end of a window of consecutive SBFD slots.

Clause 16: A method for wireless communication at a wireless node, comprising: transmitting first signaling configuring a user equipment (UE) with semi-persistent resources for communications with the wireless node; transmitting second signaling indicating additional information relating to a symbol type of the semi-persistent resources and a UE mode of operation for the communications; and communicating on the semi-persistent resources in accordance with the additional information.

Clause 17: The method of Clause 16, wherein the communications comprise at least one of semi-persistently scheduled (SPS) or configured grant (CG) based transmissions or receptions.

Clause 18: The method of any one of Clauses 16-17, wherein: the additional information indicates restriction to a symbol type and a UE mode of operation for the communications, and the communicating comprises communicating on the semi-persistent resources in accordance with the restriction.

Clause 19: The method of Clause 18, wherein the restriction includes at least one of: a restriction to use the semi-persistent resources in half duplex (HD) slots only, a restriction to use the semi-persistent resources in subband full duplex (SBFD) slots indicated for HD mode of operation for the UE, a restriction to use the semi-persistent resources in SBFD slots indicated for full duplex (FD) mode of operation for the UE, or a restriction to use the semi-persistent resources in any SBFD slots regardless of indicated UE mode of operation.

Clause 20: The method of any one of Clauses 16-19, wherein: the additional information indicates adaptations to be applied to the communications for one or more combinations of symbol type and UE mode of operation; and the communicating comprises applying the adaptations in at least one slot of the semi-persistent resources.

Clause 21: The method of Clause 20, wherein at least one of the adaptations involves rate matching in the at least one slot.

Clause 22: The method of Clause 20, wherein at least one of the adaptations involves adapting one or more parameters associated with communications in the at least one slot.

Clause 23: The method of Clause 22, wherein the one or more parameters comprise at least one of: a resource block (RB) offset in the at least one slot, a rank associated with the communications in the at least one slot, or a modulation and coding scheme (MCS) associated with the communications in the at least one slot.

Clause 24: The method of Clause 20, wherein the adaptations include at least one of: adaptations specific for a subband full duplex (SBFD) slot and a full duplex (FD) UE mode, adaptations specific for an SBFD slot and a half duplex (HD) UE mode, or adaptations specific for an SBFD slot and an FD UE mode, where only a downlink transmission or only an uplink transmission is scheduled in the SBFD slot.

Clause 25: The method of Clause 20, wherein: the resources include first resources for SPS based communications and second resources for CG based communications; and the first resources and the second resources overlap in at least a first slot.

Clause 26: The method of Clause 25, further comprising performing one or more actions based on the overlap.

Clause 27: The method of Clause 26, wherein the one or more actions comprise at least one of: dropping the CG based communications in at least the first slot; dropping the SPS based communications in at least the first slot; performing the CG based communications in accordance with an adaptation specific for the overlap; performing the SPS based communications in accordance with an adaptation specific for the overlap; or performing the SPS based communications and the CG based communications in accordance with the indicated adaptations.

Clause 28: The method of Clause 25, wherein the first signaling indicates permissibility of converting a mode of operation of the UE from half duplex (HD) mode to full duplex (FD) mode.

Clause 29: The method of Clause 28, wherein the UE mode of operation is converted from HD mode to FD mode based on the overlap and the first signaling.

Clause 30: The method of Clause 29, wherein the conversion is at least one of: limited to the at least the first slot, valid for a configured quantity of slots, or valid until an end of a window of consecutive SBFD slots.

Clause 31: An apparatus, comprising: at least one memory comprising executable instructions; and at least one processor configured to execute the executable instructions and cause the apparatus to perform a method in accordance with any combination of Clauses 1-30.

Clause 32: An apparatus, comprising means for performing a method in accordance with any combination of Clauses 1-30.

Clause 33: A non-transitory computer-readable medium comprising executable instructions that, when executed by at least one processor of an apparatus, cause the apparatus to perform a method in accordance with any combination of Clauses 1-30.

Clause 34: A computer program product embodied on a computer-readable storage medium comprising code for performing a method in accordance with any combination of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for receiving, means for communicating, means for performing, and means for transmitting may comprise one or more processors, such as one or more of the processors described above with reference to FIG. 17.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
at least one memory comprising computer-executable instructions; and
one or more processors configured to execute the computer-executable instructions and cause the apparatus to:
receive first signaling configuring the UE with semi-persistent resources for communications with a wireless node;
receive second signaling indicating additional information relating to a symbol type of the semi-persistent resources and a UE mode of operation for the communications; and
communicate on the semi-persistent resources in accordance with the additional information.

2. The apparatus of claim 1, wherein the communications comprise at least one of semi-persistently scheduled (SPS) or configured grant (CG) based transmissions or receptions.

3. The apparatus of claim 1, wherein:
the additional information indicates restriction to a symbol type and a UE mode of operation for the communications, and
the communicating comprises communicating on the semi-persistent resources in accordance with the restriction.

4. The apparatus of claim 3, wherein the restriction includes at least one of:
a restriction to use the semi-persistent resources in half duplex (HD) slots only,
a restriction to use the semi-persistent resources in subband full duplex (SBFD) slots indicated for HD mode of operation for the UE,
a restriction to use the semi-persistent resources in SBFD slots indicated for full duplex (FD) mode of operation for the UE, or
a restriction to use the semi-persistent resources in any SBFD slots regardless of indicated UE mode of operation.

5. The apparatus of claim 1, wherein:
the additional information indicates adaptations to be applied to the communications for one or more combinations of symbol type and UE mode of operation; and
the communicating comprises applying the adaptations in at least one slot of the semi-persistent resources.

6. The apparatus of claim 5, wherein at least one of the adaptations involves rate matching in the at least one slot.

7. The apparatus of claim 5, wherein at least one of the adaptations involves adapting one or more parameters associated with communications in the at least one slot.

8. The apparatus of claim 7, wherein the one or more parameters comprise at least one of:
a resource block (RB) offset in the at least one slot,
a rank associated with the communications in the at least one slot, or
a modulation and coding scheme (MCS) associated with the communications in the at least one slot.

9. The apparatus of claim 5, wherein the adaptations include at least one of:
adaptations specific for a subband full duplex (SBFD) slot and a full duplex (FD) UE mode,
adaptations specific for an SBFD slot and a half duplex (HD) UE mode, or
adaptations specific for an SBFD slot and an FD UE mode, where only a downlink transmission or only an uplink transmission is scheduled in the SBFD slot.

10. The apparatus of claim 5, wherein:
the resources include first resources for SPS based communications and second resources for CG based communications; and
the first resources and the second resources overlap in at least a first slot.

11. The apparatus of claim 10, wherein the one or more processors are further configured to cause the apparatus to:
perform one or more actions based on the overlap.

12. The apparatus of claim 11, wherein the one or more actions comprise at least one of:
dropping the CG based communications in at least the first slot;
dropping the SPS based communications in at least the first slot;
performing the CG based communications in accordance with an adaptation specific for the overlap;
performing the SPS based communications in accordance with an adaptation specific for the overlap; or
performing the SPS based communications and the CG based communications in accordance with the indicated adaptations.

13. The apparatus of claim 10, wherein the first signaling indicates permissibility of converting a mode of operation of the UE from half duplex (HD) mode to full duplex (FD) mode.

14. The apparatus of claim 13, wherein the one or more processors are further configured to cause the apparatus to:
convert the UE mode of operation from HD mode to FD mode based on the overlap and the first signaling.

15. The apparatus of claim 14, wherein the conversion is at least one of:
limited to the at least the first slot,
valid for a configured quantity of slots, or
valid until an end of a window of consecutive SBFD slots.

16. An apparatus for wireless communication at a wireless node, comprising:
at least one memory comprising computer-executable instructions; and
one or more processors configured to execute the computer-executable instructions and cause the apparatus to:
transmit first signaling configuring a user equipment (UE) with semi-persistent resources for communications with the wireless node;
transmit second signaling indicating additional information relating to a symbol type of the semi-persistent resources and a UE mode of operation for the communications; and
communicate on the semi-persistent resources in accordance with the additional information.

17. The apparatus of claim 16, wherein the communications comprise at least one of semi-persistently scheduled (SPS) or configured grant (CG) based transmissions or receptions.

18. The apparatus of claim 16, wherein:
the additional information indicates restriction to a symbol type and a UE mode of operation for the communications, and
the communicating comprises communicating on the semi-persistent resources in accordance with the restriction.

19. The apparatus of claim 18, wherein the restriction includes at least one of:
a restriction to use the semi-persistent resources in half duplex (HD) slots only,
a restriction to use the semi-persistent resources in subband full duplex (SBFD) slots indicated for HD mode of operation for the UE,
a restriction to use the semi-persistent resources in SBFD slots indicated for full duplex (FD) mode of operation for the UE, or
a restriction to use the semi-persistent resources in any SBFD slots regardless of indicated UE mode of operation.

20. A method for wireless communication at a user equipment (UE), comprising:
receiving first signaling configuring the UE with semi-persistent resources for communications with a wireless node;
receiving second signaling indicating additional information relating to a symbol type of the semi-persistent resources and a UE mode of operation for the communications; and
communicating on the semi-persistent resources in accordance with the additional information.
